(19) United States
(12) Patent Application Publication
(10) Pub. No.: US 2014/0286071 A1
(43) Pub. Date: Sep. 25, 2014

(54) POWER CONVERSION DEVICE HAVING BATTERY HEATING FUNCTION

(71) Applicant: Samsung SDI Co., Ltd., Yongin-si (KR)

(72) Inventor: Sun-Ho CHOI, Yongin-si (KR)

(21) Appl. No.: 13/943,942

(22) Filed: Jul. 17, 2013

(30) Foreign Application Priority Data
Mar. 20, 2013 (KR) 10-2013-0029834

(51) Int. Cl. H02M 11/00

(52) U.S. Cl. CPC H02M 11/00
USPC 363/178

(57) ABSTRACT

A power conversion device having a battery heating function includes a battery, a converter, a temperature sensor, and a controller. The converter is coupled between the battery and a DC link. The temperature sensor measures a temperature of the battery. The controller controls the converter based on the temperature measured by the temperature sensor so that the battery repeats charging and discharging during the battery heating mode, thereby heating the battery.

### CROSS-REFERENCE TO RELATED APPLICATION

The present application claims priority under 35 U.S.C. §119 to and benefit of Korean Patent Application No. 10-2013-0029834, filed on Mar. 20, 2013, in the Korean Intellectual Property Office, and entitled: “Power Conversion Device Having Battery Heating Function,” which is incorporated by reference herein in its entirety.

### BACKGROUND

1. Field

Embodiments relate to a power conversion device having a battery heating function.

2. Description of the Related Art

As environmental disruption, resource depletion, etc., are increasingly problematic, interest in an energy storage system capable of storing energy and efficiently using the stored energy is increased. A battery for storing and supplying electric power according to the amount of a load is included in the energy storage system.

### SUMMARY

One or more embodiments are directed to providing a power conversion device having a battery heating function, including a battery, a converter coupled between the battery and a DC link, a temperature sensor measuring a temperature of the battery, and a controller that controls the converter in accordance with the temperature of the battery so that the battery repeats charging and discharging during a battery heating mode, thereby heating the battery.

The controller may determine the number of times of charging and discharging of the battery during the battery heating mode, corresponding to the temperature measured by the temperature sensor.

The converter may include a first inductor coupled between the battery and a first node; a first switching element coupled between the first node and the DC link; and a second switching element coupled between the first node and a ground power source.

The converter may further include a second inductor coupled between the battery and a second node; a third switching element coupled between the second node and the DC link; and a fourth switching element coupled between the second node and the ground power source.

The controller may perform switching on the first switching element while maintaining the second switching element in an off-state in order to perform a charging operation of the battery.

The controller may perform switching on the second switching element while maintaining the first switching element in the off-state in order to perform a discharging operation of the battery.

The controller may perform switching on the first and third switching elements while maintaining the second and fourth switching elements in the off-state in order to perform the charging operation of the battery.

The controller may perform switching on the second and fourth switching elements while maintaining the first and third switching elements in the off-state in order to perform the discharging operation of the battery.

The first and third switching elements may perform on-off operations at the same time.

The second and fourth switching elements may perform on-off operations at the same time.

Each switching element may be a transistor.

The converter may further include a recovery diode coupled in parallel to each switching element.

When the temperature of the battery during the progress time of the battery heating mode corresponds to a predetermined reference value or more, the controller may exit the battery heating mode.

The controller may determine a progress time for charging/discharging the battery in accordance with the temperature measured by the temperature sensor.

### BRIEF DESCRIPTION OF THE DRAWINGS

Features will become apparent to those of skill in the art by describing in detail exemplary embodiments with reference to the attached drawings in which:

FIG. 1 illustrates a block diagram of a power conversion device according to an embodiment.

FIG. 2 illustrates a diagram of a battery heating operation according to the embodiment.

FIG. 3 illustrates a circuit diagram of a bidirectional converter according to the embodiment.

FIG. 4 illustrates a circuit diagram of a bidirectional converter according to another embodiment.

FIG. 5 illustrates a block diagram of an energy storage system employing the power conversion device according to the embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Hereinafter, a power conversion device having a battery heating function according to embodiments will be described with reference to the accompanying drawings.

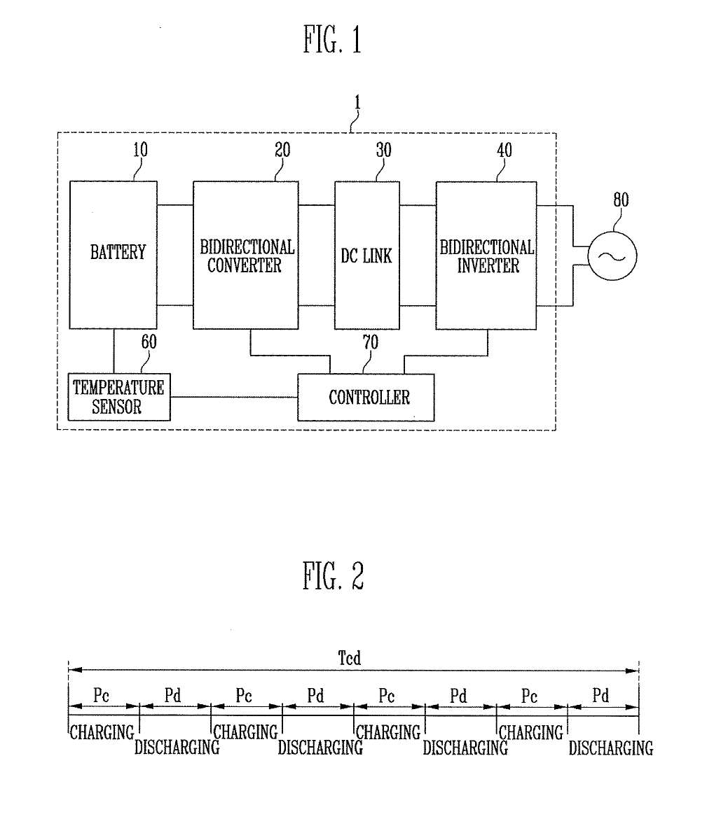

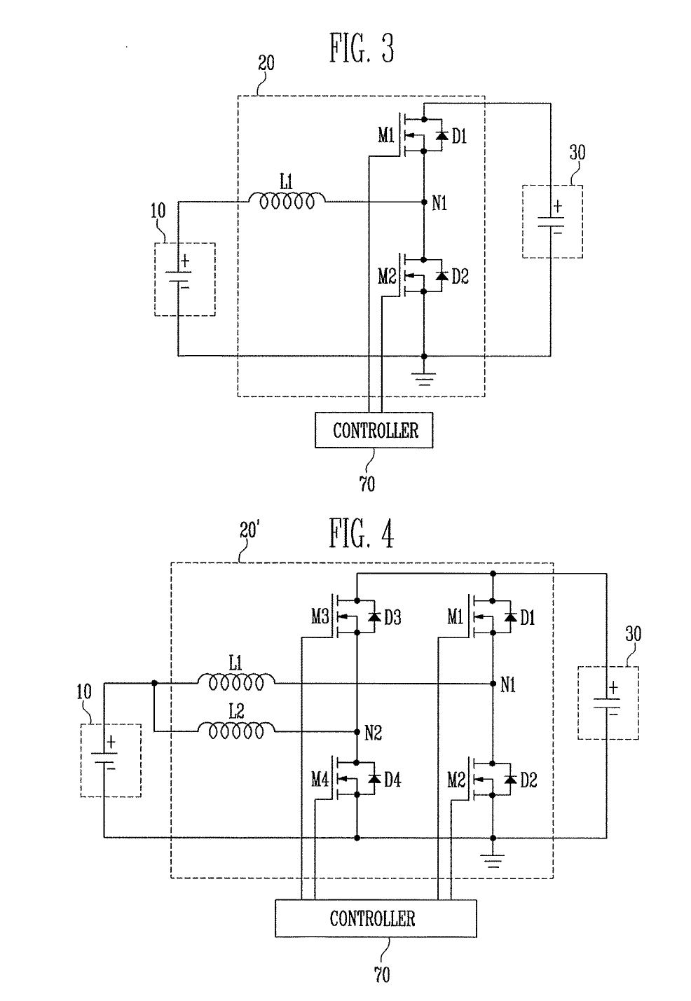

FIG. 1 illustrates a block diagram of a power conversion device according to an embodiment. FIG. 2 illustrates a diagram of a battery heating operation according to the embodiment.

Referring to FIG. 1, the power conversion device 1 having a battery heating function (hereinafter, referred to as a power conversion device) includes a battery 10, a bidirectional converter 20, a DC link 30, and a controller 70.

The battery 10 may be a secondary battery that can be repeatedly charged and discharged. For example, the battery 10 may be a nickel-cadmium battery, lead storage battery, nickel metal hydride battery (NiMH), lithium ion battery, lithium polymer battery, etc. However, embodiments are not limited thereto.

The bidirectional converter 20 is coupled between the battery 10 and the DC link 30. The bidirectional converter 20 may convert DC power having one level from the DC link 30 into DC power having another level suitable for the battery 10 and transmit the converted DC power to the battery 10. The bidirectional converter 20 may convert DC power having one level from the battery 10 into DC power having another level suitable for the DC link 30 and transmit the converted DC power to the DC link 30.

For example, the bidirectional converter 20 may be implemented as a bidirectional DC-DC converter capable of performing a buck-boost operation. The bidirectional converter 20 may generate a charging/discharging path of the battery 10 between the battery 10 and the DC link 30 under the control of the controller 70.

The battery 10 may be coupled to the bidirectional converter 20 through a battery monitoring system 190 (see FIG. 5).

The DC link 30 may perform a function of temporarily storing DC power output from the bidirectional converter 20 and transmitting the stored power to another component, e.g., a bidirectional inverter 40. In particular, the DC link 30 may store DC power output from the bidirectional inverter 40 and transmitting the stored power to the bidirectional converter 20.

The bidirectional inverter 40 may convert DC power provided from the DC link 30 into AC power and output the converted AC power to an electric power system 80, etc.

The controller 70 may control a charging/discharging operation of the battery 10 so that the battery 10 is normally operated by increasing the temperature of the battery 10. To this end, the controller 70 may control the bidirectional converter 20 so that the battery 10 repeats charging and discharging operations during a battery heating mode.

For example, as shown in FIG. 2, the charging and discharging operations of the battery 10 may be repetitively performed during a progress time Ted of the battery heating mode. As the charging and discharging operations are repetitively performed, the temperature of the battery 10 is increased.

The progress time Tcd of the battery heating mode in which the charging and discharging operations are repetitively performed to heat the battery 10 and/or the number of times of charging and discharging during the progress time Tcd may be determined according to the temperature of the battery 10.

To this end, the power conversion device according to this embodiment may further include a temperature sensor 60. The temperature sensor 60 performs a function of measuring a temperature of the battery 10. The temperature sensor 60 may transmit information on the measured temperature to the controller 70.

Accordingly, the controller 70 may calculate the progress time Tcd of the battery heating mode, based on the temperature of the battery 10, transmitted from the temperature sensor 60. The progress time Tcd of the battery heating mode may be determined through a separate look-up table or separate numerical formula.

Alternatively or additionally, the controller 70 may calculate the number of times of charging and discharging during the battery heating mode, based on the temperature of the battery 10, transmitted from the temperature sensor 60. In this case, the number of times of charging and discharging of the battery 10 may be determined through a separate look-up table or separate numerical formula. For example, as shown in FIG. 2, the number of times of each of the charging and discharging may be determined as four through the procedure described above.

When the temperature of the battery 10, measured by the temperature sensor 60, during the performance of the battery heating mode corresponds to a predetermined reference value or more, the controller 70 may finish the battery heating mode and return to a general driving mode. That is, when the battery 10 is heated to a temperature at which the battery 10 can be normally operated, the operation of heating the battery 10 is not required any more, and therefore, the battery heating mode may be exited.

FIG. 3 illustrates a circuit diagram of the bidirectional converter 20 according to the embodiment. Referring to FIG. 3, the bidirectional converter 20 according to this embodiment may include a first inductor L1, a first switching element M1, and a second switching element M2.

The first inductor L1 may be coupled between the battery 10 and a first node N1.

In particular, a first end of the first inductor L1 may be electrically coupled to a positive (+) electrode of the battery 10 and a second end of the first inductor L1 may be electrically coupled to the first node N1.

The first switching element M1 may be coupled between the first node N and the DC link 30. The second switching element M2 may be coupled between the first node N1 and a ground power source. The first node N1 may be defined as a common contact of the first inductor L1, a first switching element M1, and the second switching element M2.

On-off operations of the first and second switching elements M1 and M2 may be controlled by the controller 70. Specifically, a first electrode of the first switching element M1 may be coupled to a positive (+) terminal of the DC link 30 and a second electrode of the first switching element M1 may be coupled to the first node N1. A control electrode of the first switching element M1 may be coupled to the controller 70. A first electrode of the second switching element M2 may be coupled to the first node N1, and a second electrode of the second switching element M2 may be coupled to the ground power source. A control electrode of the second switching element M2 may be coupled to the controller 70.

Recovery diodes D1 and D2 may be coupled in parallel to the switching elements M1 and M2, respectively. In detail, a first recovery diode D1 may be coupled in parallel to the first switching element M1 and a second recovery diode D2 may be coupled in parallel to the second switching element M2. Specifically, an anode of the first recovery diode D1 may be coupled to the second electrode of the first switching element MI, and a cathode of the first recovery diode D1 may be coupled to the first electrode of the first switching element M1. An anode of the second recovery diode D2 may be coupled to the second electrode of the second switching element M2, and a cathode of the second recovery diode D2 may be coupled to the first electrode of the second switching element M2.

The first and second switching elements M1 and M2 may be implemented as transistors. The controller 70 may perform switching on the first switching element M1 while maintaining the second switching element M2 in an off-state in order to perform a charging operation of the battery 10.

For example, the controller 70 may perform switching on the first switching element M1 while maintaining the second switching element M2 in the off-state during each charging period Pc included in the progress time Tcd of the battery heating mode. Accordingly, the bidirectional converter 20 can be operated in a buck mode.

When the first switching element M1 is turned on during the charging period Pc, a current path may be formed from the DC link 30 to the battery 10 via the first switching element M1 and the first inductor L1. When the first switching element M1 is turned off during the charging period Pc, a current path may be formed from the first inductor L1 to the second recovery diode D2 via the battery 10. Thus, the battery 10 can perform the charging operation during the charging period Pc.

The controller 70 may perform switching on the second switching element M2 while maintaining the first switching element M1 in the off-state in order to perform a discharging operation of the battery 10. For example, the controller 70 may perform switching on the second switching element M2 while maintaining the first switching element M1 in the off-state during each discharging period Pd included in the progress time Tcd of the battery heating mode. Accordingly, the bidirectional converter 20 can be operated in a boost mode.

When the second switching element M2 is turned on during the discharging period Pd, a current path may be formed from the battery 10 to the second switching element M2 via the first inductor L1. When the second switching element M2 is turned off during the discharging period Pd, a current path may be formed from the battery 10 to the DC link 30 via the first inductor L1 and the first recovery diode D1. Thus, the battery 10 can perform the discharging operation during the discharging period Pd.

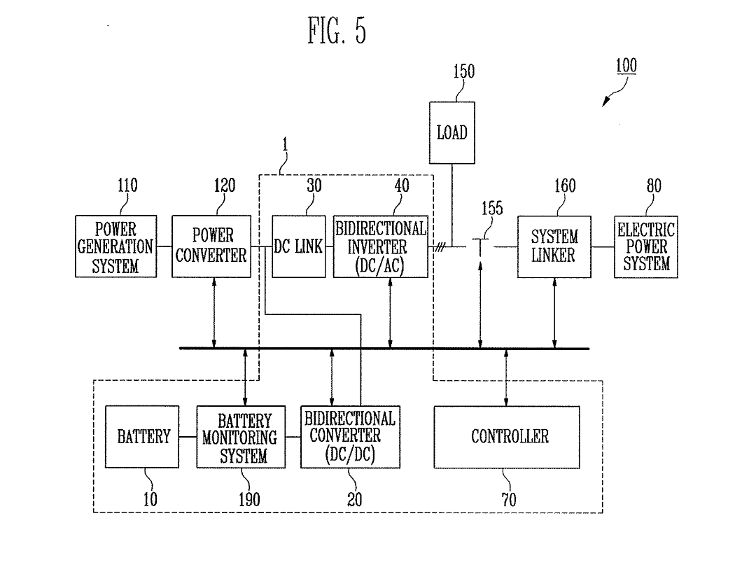

FIG. 4 illustrates a circuit diagram of a bidirectional converter according to another embodiment. In this embodiment, descriptions of components overlapping with those in the embodiment shown in FIG. 3 will be omitted.

Referring to FIG. 4, a bidirectional converter 20′ according to this embodiment may further include a second inductor L2, a third switching element M3, and a fourth switching element M4, in addition to the first inductor L1, the first switching element M1, and the second switching element M2, which are described above. The second inductor L2, the third switching element M3, and the fourth switching element M4, may further improve the battery heating effect by increasing charging/discharging current of the battery 10.

The second inductor L2 may be coupled between the battery 10 and a second node N2. In particular, a first end of the second inductor L2 may be electrically coupled to the positive (+) electrode of the battery 10 and a second end of the second inductor L2 may be electrically coupled to the second node N2.

The third switching element M3 may be coupled between the second node N2 and the DC link 30. The fourth switching element M4 may be coupled between the second node N2 and the ground power source. The second node N2 may be defined as a common contact of the second inductor L2, the third switching element M3 and the fourth switching element M4.

On-off operations of the third and fourth switching element M3 and M4 may be controlled by the controller 70. Specifically, a first electrode of the third switching element M3 may be coupled to the positive (+) terminal of the DC link 30 and a second electrode of the third switching element M3 may be coupled to the second node N2. A control electrode of the third switching element M3 may be coupled to the controller 70. A first electrode of the fourth switching element M4 may be coupled to the second node N2, and a second electrode of the fourth switching element M4 may be coupled to the ground power source. A control electrode of the fourth switching element M4 may be coupled to the controller 70.

Recovery diodes D3 and D4 may be coupled in parallel to the switching elements M3 and M4, respectively. In particular, a third recovery diode D3 may be coupled in parallel to the third switching element M3, and a fourth recovery diode D4 may be coupled in parallel to the fourth switching element M4. Specifically, an anode of the third recovery diode D3 may be coupled to the second electrode of the third switching element M3, and a cathode of the third recovery diode D3 may be coupled to the first electrode of the third switching element M3. An anode of the fourth recovery diode D4 may be coupled to the second electrode of the fourth switching element M4 and a cathode of the fourth recovery diode D4 may be coupled to the first electrode of the fourth switching element M4.

The third and fourth switching elements M3 and M4 may be implemented as transistors. The controller 70 may perform switching on the first and third switching elements M1 and M3 while maintaining the second and fourth switching elements M2 and M4 in the off-state in order to perform a charging operation of the battery 10.

For example, the controller 70 may perform switching on the first to third switching elements M1 to M3 while maintaining the second and fourth switching elements M2 and M4 in the off-state during each charging period Pc included in the progress time Tcd of the battery heating mode. The first and third switching elements M1 and M3 may perform on-off operations at the same time. Accordingly, the bidirectional converter 20′ can be operated in a buck mode. The battery can perform the charging operation during the charging period Pc through the procedure described above.

The controller 70 may perform switching on the second and fourth switching elements M2 and M4 while maintaining the first and third switching elements M1 and M3 in the off-state in order to perform a discharging operation of the battery 10. For example, the controller 70 may perform switching on the second and fourth switching elements M2 and M4 while maintaining the first and third switching elements M1 and M3 in the off-state during each discharging period Pd included in the progress time Tcd of the battery heating mode. Accordingly, the bidirectional converter 20′ can be operated in a boost mode. The second and fourth switching elements M2 and M4 may perform on-off operations at the same time. The battery 10 may perform the discharging operation during the discharging period Pd through the procedure described above.

FIG. 5 illustrates a block diagram of an energy storage system employing the power conversion device according to the embodiment. Referring to FIG. 5, the energy storage system 100 may include a power conversion device 1, a power generation system 110, a power converter 120, a load 150, a system linker 160, and an electric power system 80.

The power generation system 110 generates electrical energy and supplies the generated electrical energy to the energy storage system 100. The power generation system 110 may be a new energy and renewable energy generation system using renewable energy, e.g., sunlight, water, subterranean heat, rainfall, living organism, etc.

For example, the power generation system 110 may be a solar generation system that converts solar energy such as solar heat and sunlight into electrical energy through solar cells. In addition, the power generation system 110 may be a wind power generation system for converting wind power into electrical energy, a subterranean heat generation system for converting subterranean heat into electrical energy, a hydraulic power generation system, an ocean power generation system, and so forth.

The power generation system may be a new energy generation system that produces electrical energy using fuel cells or produces electrical energy using hydrogen, coal liquefied gas, medium quality residual oil gas, and so forth.

It will be apparent that the power generation system 110 may be implemented in various manners in addition to the aforementioned examples.

The power converter 120 is coupled between the power generation system 110 and the DC link 30. The power converter 120 converts electric power generated in the power generation system 110 into DC voltage. The operation of the power converter 120 may be changed depending on the electric power generated in the power generation system 110.

For example, when the power generation system 110 generates AC voltage, the power converter 120 converts the AC voltage into DC voltage. When the power generation system 110 generates DC voltage, the power converter 120 boosts or drops the DC voltage.

For example, when the power generation system 110 is a solar generation system, the power converter 120 may be a maximum power point tracking (MPPT) converter that detects the maximum power point according to a change in the amount of sunlight or a change in the temperature of solar heat and generates electric power.

In addition, various kinds of converters or rectifiers may be used as the power converter 120.

The DC link 30 temporarily stores DC voltage provided from the power converter 120. The DC link 30 may be substantially a large-capacity capacitor. Thus, the DC link 30 may store stabilized DC power by removing an AC component from the DC power output from the power converter 120. In addition, the DC link 30 may also stabilize DC voltage provided from the bidirectional inverter 40 or the bidirectional converter 20 described above and temporarily stores the stabilized DC voltage.

The bidirectional inverter 40 converts the DC power provided from the DC link 30 into commercial AC power and outputs the converted AC power. In particular, the bidirectional inverter 40 converts DC voltage from the power generation system 110 or the battery 10 into commercial AC voltage available in a home and outputs the converted AC voltage. The bidirectional inverter 40 converts commercial AC voltage provided from the electric power system 80 into DC power and provides the converted DC power to the DC link 30. The electric power stored in the DC link 30 is provided to the battery 10 through the bidirectional converter 20.

The load 150 may be a home or industrial facility using commercial AC voltage. The load 150 receives commercial AC power applied from the power generation system 110, the battery 10 or the electric power system 80.

The system linker 160 couples the bidirectional inverter 40 and the electric power system 80. For example, the system linker 160 controls a voltage fluctuation range, restricts harmonics, removes a DC component, etc. The system linker 160 provides AC power of the bidirectional inverter 40 to the electric power system 80 or provides AC power of the electric power system 80 to the bidirectional inverter 40.

The electric power system 80 is an AC power system provided from an electric power company or power generation company. For example, the electric power system 80 is an electrical link formed in a wide area, including power stations, transformer substations and power transmission lines. The electric power system 80 is typically referred to as a grid.

The battery monitoring system 190 optimally maintains and manages the state of the battery 10. For example, the battery monitoring system 190 monitors the voltage, current and temperature of the battery 10. When an error occurs in the battery 10, the battery monitoring system 190 warns a user of the error. In addition, the battery monitoring system 190 calculates the state of charge (SOC) and state of health (SOH) of the battery 10, and performs cell balancing of equalizing the voltage or capacity of each battery. The battery monitoring system 190 may control a cooling system, e.g., a fan (not shown), in order to prevent overheating of the battery 10. The temperature sensor 60 measuring a temperature of the battery 10 may be included in the battery monitoring system 190.

The bidirectional converter 20 may convert DC power having one level from the DC link 30 into DC power having another level suitable for the battery 10. The bidirectional converter 20 may convert DC power having one level from the battery 10 into DC power having another level suitable for the DC link 30.

The controller 70 monitors and controls the power converter 120, the bidirectional inverter 40, the system linker 160, the bidirectional converter 20, and the like. The controller 70 monitors the battery monitoring system 190 by communicating with the battery monitoring system 190. In particular, the controller 70 may sense voltage, current, and temperature from each of the power converter 120, the bidirectional inverter 40, the system linker 160, and the bidirectional converter 20, and control each of the power converter 120, the bidirectional inverter 40, the system linker 160, and the bidirectional converter 20. In addition, the controller 70 may cut off a circuit breaker 155 coupled between the load 150 and the system linker 160 in an emergency situation.

By way of summation and review, a battery may receive electric power supplied from an external power source so as to store the electric power, and may supply the stored electric power to an external load. However, if the temperature of the battery is low due the influence of an intense cold region or ambient environment, e.g., a cold winter, the operating state of an electrolyte or the like of the battery may not be quickly activated. Therefore, the operation of the battery may be abnormal.

As described above, embodiments may provide a power conversion device configured to perform a battery heating function without using a separate heating device. In particular, charging/discharging of the battery may be performed as required when a temperature sensed is below a temperature required for normal operation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A power conversion device having a battery heating function, comprising:
a battery;
a converter coupled between the battery and a DC link;
a temperature sensor measuring a temperature of the battery; and
a controller that controls the converter based on the temperature measured by the temperature sensor, such that the battery repeats charging and discharging during a battery heating mode, thereby heating the battery.

2. The power conversion device as claimed in claim 1, wherein the controller determines a number of times of charging and discharging of the battery during the battery heating mode in accordance with the temperature measured by the temperature sensor.

3. The power conversion device as claimed in claim 1, wherein the converter includes:
a first inductor coupled between the battery and a first node;
a first switching element coupled between the first node and the DC link; and
a second switching element coupled between the first node and a ground power source.

4. The power conversion device as claimed in claim 3, wherein the converter further includes:
a second inductor coupled between the battery and a second node;
a third switching element coupled between the second node and the DC link; and
a fourth switching element coupled between the second node and the ground power source.

5. The power conversion device as claimed in claim 4, wherein the controller switches on the first and third switching elements while maintaining the second and fourth switching elements in an off-state in order to perform the charging of the battery.

6. The power conversion device as claimed in claim 5, wherein the controller switches on the second and fourth switching elements while maintaining the first and third switching elements in the off-state in order to perform the discharging of the battery.

7. The power conversion device as claimed in claim 6, wherein the second and fourth switching elements are turned on and off simultaneously.

8. The power conversion device as claimed in claim 5, wherein the first and third switching elements are turned on and off simultaneously.

9. The power conversion device as claimed in claim 3, wherein the controller switches on the first switching element while maintaining the second switching element in an off-state in order to perform the charging of the battery.

10. The power conversion device as claimed in claim 9, wherein the controller switches on the second switching element while maintaining the first switching element in the off-state in order to perform the discharging of the battery.

11. The power conversion device as claimed in claim 3, wherein each switching element is a transistor.

12. The power conversion device as claimed in claim 3, wherein the converter further includes a recovery diode coupled in parallel to each switching element.

13. The power conversion device as claimed in claim 1, wherein, when the temperature of the battery during a progress time of the battery heating mode corresponds to a predetermined reference value or more, the controller exits the battery heating mode.

14. The power conversion device as claimed in claim 1, wherein the controller determines a progress time for charging/discharging the battery in accordance with the temperature measured by the temperature sensor.
